(19) United States
(12) Patent Application Publication
(10) Pub. No.: US 2007/0260492 A1
(43) Pub. Date: Nov. 8, 2007

(54) MASTER PATIENT INDEX

(75) Inventors: Craig Frederick Feied, Washington, DC (US); Fidrik Iskandar, Fairfax, VA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/683,799

(22) Filed: Mar. 8, 2007

Related U.S. Application Data
(60) Provisional application No. 60/780,376, filed on Mar. 9, 2006.

(51) Int. Cl. G06F 19/00

(52) U.S. Cl. 705/3

(57) ABSTRACT

A system and/or method that can maintain a master patient index in a health care context is disclosed. The index enables a health-care professional or entity to collect, access and/or retrieve a cohort of health-related data elements (e.g., patient information) from a variety of sources and of differing formats. The cohort of data elements can be displayed such that a health care entity can easily toggle through the patient-related data without a need to access format-specific applications.

### CROSS-REFERENCE TO RELATED APPLICATIONS

This application claims the benefit of U.S. Provisional Patent application Ser. No. 60/780,376 entitled “MASTER PATIENT INDEX” and filed Mar. 9, 2006. The entirety of the above-noted application is incorporated by reference herein.

### BACKGROUND

Computers and computer related technology have evolved significantly over the past several decades to the point where vast amounts of computer readable data is being created and stored daily. Digital computers were initially simply very large calculators designed to aid performance of scientific calculations. Only many years later had computers evolved to a point where they were able to execute stored programs. Subsequent rapid emergence of computing power produced personal computers that were able to facilitate document production and printing, bookkeeping as well as business forecasting, among other things. Constant improvement of processing power coupled with significant advances in computer memory and/or storage devices (as well as expediential reduction in cost) have led to persistence and processing of an enormous volume of data, which continues today. For example, data warehouses are now widespread technologies employed to support business decisions over terabytes of data.

Unfortunately, today, data warehouses are maintained separately within relational databases and are most often directed to application specific environments. A relational database refers to a data storage mechanism that employs a relational model in order to interrelate data. These relationships are defined by a set of tuples that all have a common attribute. The tuples are most often represented in a two-dimensional table, or group of tables, organized in rows and columns. In the health care industry, application-specific data is stored in individual data bases which require a health care provider to maintain a variety of applications in order to access and/or manipulate the data. These variety of applications makes data maintenance expensive and cumbersome.

The sheer volume of collected data in databases (e.g., relational databases) made it nearly impossible for a human being alone to perform any meaningful analysis, as was done in the past. This predicament led to the development of data mining and associated tools. Data mining relates to a process of exploring large quantities of data in order to discover meaningful information about the data that is generally in the form of relationships, patterns and rules. In this process, various forms of analysis can be employed to discern such patterns and rules in historical data for a given application or business scenario. Such information can then be stored as an abstract mathematical model of the historical data, referred to as a data-mining model (DMM). After the DMM is created, new data can be examined with respect to the model to determine if the data fits a desired pattern or rule.

Conventionally, data mining is employed upon data in a closed environment, frequently by large corporations, for example, to understand complex business processes. This can be achieved through discovery of relationships or patterns in data relating to past behavior of a business process. Such patterns can be utilized to improve the performance of a process by exploiting favorable and avoiding problematic patterns.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system and/or method that can maintain a master patient index in a health care context. The index enables a health-care professional or entity to collect, access and/or retrieve health-related data (e.g., patient information) from a variety of sources, including but not limited to, scanned documents, X-rays, electrocardiograms, medical imaging procedures, lab results, dictated reports of surgery, etc. These aggregated data elements can be rendered to a health care entity in an organized manner such that the health care professional can easily toggle through patient-related data which is retrieved from disparate sources. In addition to health procedure-specific information, other patient information (e.g., demographics, contact information) can be collected and provided to a health-related entity and viewed in a unified manner.

In an aspect, the innovation employs a patient index together with a data exploration engine (e.g., data mining engine) to identify trends and patterns within the data. Additionally, the system can maintain an index that facilitates collection of data from a variety of sources such as scanned documents, X-rays, electrocardiograms, medical imaging procedures, lab results, dictated reports of surgery, etc. In other words, the innovation can employ the index and data mining mechanisms to compile and render patient-specific data which conventionally was only available by accessing procedure-specific applications.

In operation, a health care professional can obtain information related to a patient's past, present and possible future condition. In doing so, a health entity or professional can view a patient's hospital records, medication and allergy lists, lab studies, as well as X-rays and other image scans. It will be appreciated that, unified access to this information can greatly enhance quality of care provided by a health care entity.

In yet other aspects, inferences can be made based upon gathered information. By way of example, prognosis can be made by evaluating ‘the big picture’ as opposed to conventional systems that look at each element of data independently. Here, the system can analyze and/or evaluate all of the data in order to reach an overall health-related prognosis or result. Machine learning and/or reasoning mechanisms are provided that employ a probabilistic and/or statistical-based analysis to effectuate these inferences.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a system that facilitates unified management of health-related data of varying types from varying sources in accordance with an aspect of the innovation.

FIG. 2 illustrates an example data structure of a data source in accordance with an aspect of the innovation.

FIG. 3 illustrates an example flow chart of procedures that facilitate establishing a master index in accordance with an aspect of the innovation.

FIG. 4 illustrates an example flow chart of procedures that facilitate rendering data in accordance with an aspect of the innovation.

FIG. 5 illustrates an example block diagram of a data collection component in accordance with an aspect of the innovation.

FIG. 6 illustrates an example block diagram of a data analysis component in accordance with an aspect of the innovation.

FIG. 7 illustrates an example block diagram of a data rendering component in accordance with an aspect of the innovation.

FIG. 8 illustrates an example screen shot of a unified user interface/display in accordance with an aspect of the innovation.

FIG. 9 illustrates a block diagram of a computer operable to execute the disclosed architecture.

FIG. 10 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

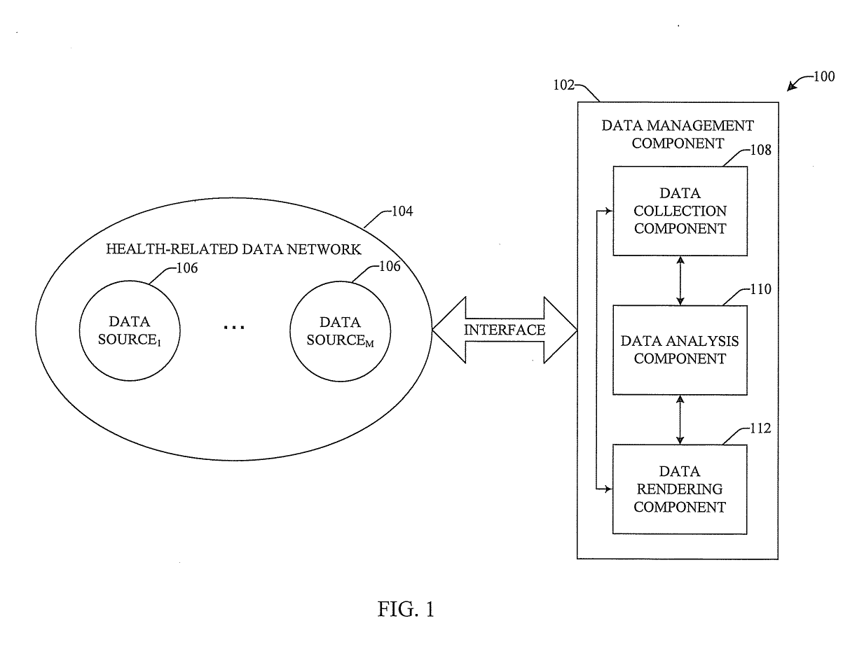

Referring initially to the drawings, FIG. 1 illustrates a system 100 that enables aggregation of data related to a patient (or group of patients) in accordance with an aspect of the innovation. Generally, the system 100 includes a data management component 102 that facilitates collection, analysis and access to health-related data 104. More specifically, health-related data component 104 can include 1 to M data sources 106, where M is an integer. It is to be understood that 1 to M data sources can be referred to collectively or individually as data sources 106.

By way of example, data sources 106 can include most any health-related data, including, but not limited to, patient photos, patient bios, patient demographics, patient history, images (e.g., X-rays, CAT scans (computed tomography), MRI scans (magnetic resonance imaging), PET scans (positron emission tomography), Ultrasounds), dictation related to a patient, scanned images of patient charts, laboratory results, medications, allergies, etc. In operation, the system 100 can score data elements within each of the sources 106 based upon a similarity to other health-related data elements. Accordingly, an index can be maintained that associates these disparate data elements based upon the similarity score.

Alternatively, more traditional data mining techniques can be employed to identify patterns and/or trends related to the data elements maintained within each of the data sources 106. The results of data mining operations can be employed to maintain an index which can be used to facilitate access to individual data elements. Alternatively, relationships between data elements can be established, ‘on-the-fly’ or as requested, such that a separate index need not be maintained. However, it will be appreciated that maintaining an index may improve time, expense and efficiency of collaborating patient-specific data elements.

As shown in FIG. 1, the data management component 102 can include a data collection component 108, a data analysis component 110 and a data rendering component 112. The collection component 108 can enable a number of functionalities associated with retention and/or location of data elements. For example, the data mining functionalities described supra can be effectuated by way of the data collection component 108. As well, data source 106 monitoring as well other data identification processes can be facilitated by way of the data collection component 108.

The data analysis component 110 can be employed to assist the data collection component 108 in identifying relevant data. It is to be understood that analysis actions can be performed upon data at data capture and/or data retrieval. In other words, as data is generated (e.g., input by a user (e.g., textually, via voice commands), created from applications, gathered from sensors, scanned from hardcopy documents), relationship and score relevance can be dynamically established. Additionally, an index can be established which provides pointers and/or links to relevant documents regardless of the document location or application format. For example, it should be understood and appreciated that the index can be employed to reference/locate documents of differing formats from distributed locations (e.g., stores). By way of more specific example, the system 100 can be used to aggregate patient information from most any participating location (e.g., doctor office, pharmacy, hospital) thereby providing a unified access or interface layer to vast amounts of information.

The rendering component 112 can be employed to access, render or display the information. Accordingly, the rendering component 112 can automatically filter and/or configure the information (e.g., data elements) in a manner to convey as desired. For example, the rendering component 112 can be employed to automatically configure data conform to display limitations of a handheld device such as a cell phone, smartphone or personal digital assistant (PDA). Further, the rendering component 100 could also limit the size of retrieved data elements in accordance with any memory or processing limitations of a subject mobile device. The features, functions and benefits of the each of these components (108, 110, 112) will be better understood upon a review of the figures that follow.

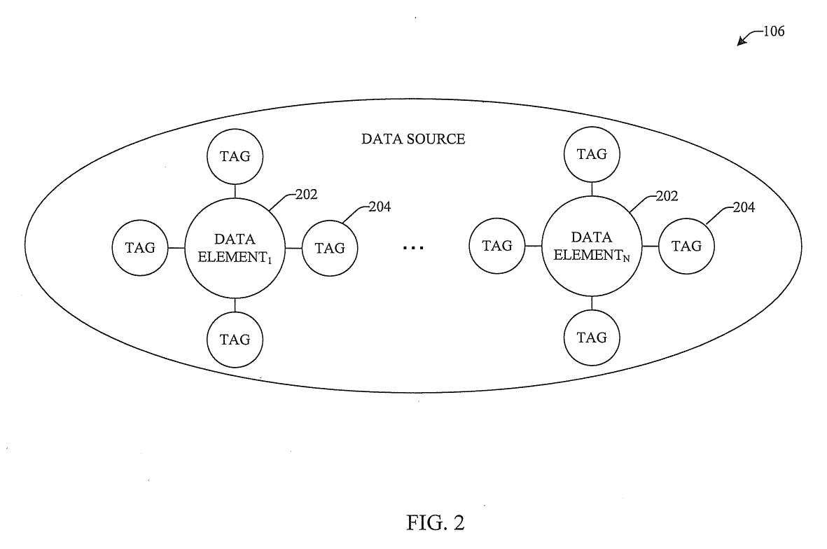

Turning now to FIG. 2, an example data source 106 is illustrated having 1 to N data elements 202, where N is an integer. As illustrated, it is to be understood that each of these data elements 202 can be wrapped or associated with metadata or tags 204 which assist in establishing a similarity score as well as to identify relationships, patterns and/or trends with regard to the patient data. Additionally, it is to be understood that tags 204 can independently be employed to effectuate data mining and/or association properties.

The similarity score itself can be embodied within a tag 204 as illustrated in FIG. 2. Moreover, as described above, the similarity score can be established ‘on-the-fly’ or ‘just-in-time’ in accordance with alternative aspects. For example, in alternate aspects, a particular data element 202 can be selected by a user whereas a similarity score threshold (e.g., policy) set by a user can be employed to render other data elements 202 from the same or similar sources 104 as a function of the similarity score and corresponding threshold.

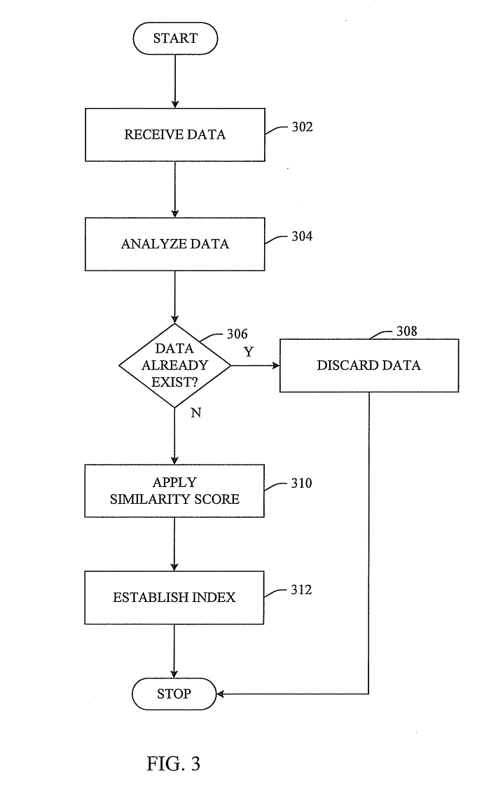

FIG. 3 illustrates a methodology of establishing an index in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

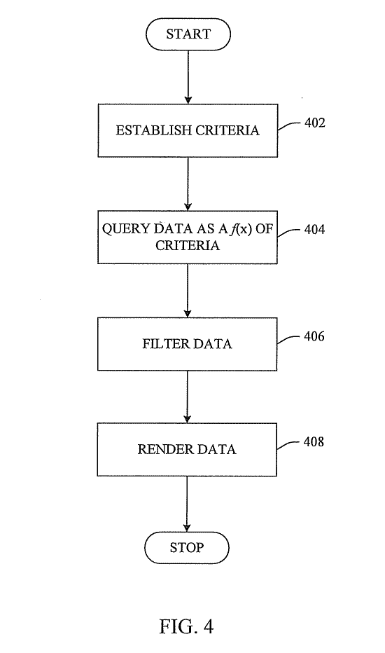

Essentially, the methodology of FIG. 3 discloses a process for creating and maintaining a master patient index using a multi-factor algorithm that assigns a similarity score and a sliding scale that allows a user to select the degree of similarity required to consider two records as belonging to the same actual entity (e.g., patient). As will be described with reference to FIG. 4 that follows, this similarity score can be used to render patient-specific data via a unified user interface (UI).

At 302, data can be received by most any input mechanism. For example, images can be scanned to convert hardcopy documents (e.g., patient records, photographs) into electronic data. Similarly, input can be received directly from imaging devices, dictation machines, user inputs, physiological sensory mechanisms or the like. While specific mechanisms of input are described herein, it is to be understood that other examples exist where data can be received (e.g., collected, input or otherwise gathered). These additional aspects are to be included within the scope of the description and claims appended hereto.

The collected data can be analyzed at 304 in order to establish context (e.g., content, patient association, date collected, origin, relevance). This analysis can be effected using various techniques including, but not limited to, keyword analysis, pattern recognition, speech recognition, optical character recognition (OCR) or the like. Once analyzed, at 306, a determination can be made to establish if the data is a duplicate.

If, at 306, it is determined that the data is a duplicate to data already within a reachable data store, the data will be discarded at 308. However, if the data is not a duplicate, at 310, a similarity score can be established and applied to the data. Thus, based upon the score applied, the data element can be referenced in the index with proper associations to other data items. Accordingly, when a search is conducted, the index can be used to render a comprehensive set of data elements as a function of predefined and/or inferred policy.

Referring now to FIG. 4, there is illustrated a methodology of searching and rendering data from a variety of sources in accordance with the innovation. At 402, search criteria can be established. It is to be understood that this criteria can be as general as, ‘all information related to Jane Doe’ to ‘information related to Jane Doe between the dates of . . . ” Effectively, most any threshold and/or identifiers can be employed to locate desired and/or relevant data.

At 404, available data can be queried as a function of established criteria. Here, data from disparate stores can be queried and filtered at 406 in view of the established criteria. Moreover, as described supra, the data can be of most any type and located in most any location. Additionally, as privacy may be a concern, the data can be additionally filtered at 406 in order to mask any sensitive data (e.g., billing information, social security number).

Once collected and filtered in accordance with desired criteria, the data can be rendered at 408. It will be appreciated that a common method of rendering data is to display the data such that a user can view the data. Here, at 408, the data can be configured as necessary so as to conform to a particular display device (e.g., liquid crystal display (LCD) monitor, cell phone, smartphone, PDA, desktop computer). Still further, the data can be rendered to an application for subsequent processing as appropriate.

In summary, there are at least two distinct concepts described within this disclosure. These distinct concepts are illustrated in FIGS. 3 and 4 which relate respectively to input/analysis of data and establishment of an index that corresponds to the inputted data and to mechanisms by which data can be searched and rendered to a user as a function of the index. Although actions are described exclusively with regard to one or the other process, it is to be understood that these actions are interchangeable and can occur within each of the other methodologies. For example, the FIG. 4 could include an action related to analysis of data whereby the retrieved data is analyzed to determine its relevance. Accordingly, based upon the analysis, a cohort can be filtered and rendered accordingly. Although not illustrated in the form of a process flow, these alternative aspects are to be included within the scope of this disclosure and claims appended hereto.

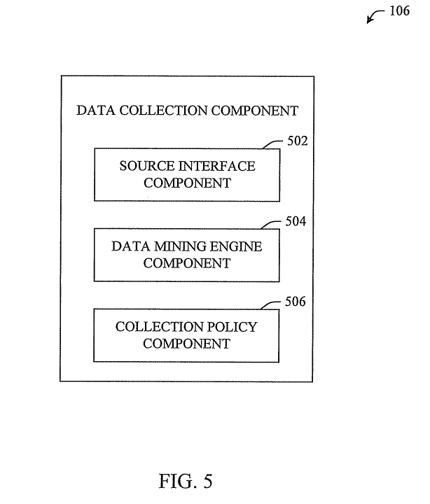

Turning now to FIG. 5, a block diagram of an example data collection component 106 in accordance with an aspect is shown. Generally, the data collection component 106 can include a source interface component 502, a data mining engine 504 and a collection policy component 506. Each of these subcomponents will be described in greater detail below.

Referring first to the source interface component 502, this component can enable communication with a source of data. For example, this component can enable data to be automatically pulled from a source (e.g., data store, sensory mechanism, etc.) In this example, the collection policy component 506 can control granularity and/or frequency of data collection. Additionally, this component enables the data collection component 106 to accept data input from most any source or origin of data. For instance, the source interface component 502 can enable communication with a scanning device (e.g., OCR, bar code, image scan, facial scan, biometric scan) such that data can be collected and thereafter analyzed by the analysis component 108.

The data mining engine component 504 can be employed to identify patterns, similarities and/or trends in data that has been collected. In aspects, this data mining engine 504 can be employed both when data is being collected for the first time as well as when querying the system in order to render data from a variety of sources as described above. In either case, the data mining engine component 504 can employ known mining techniques to establish trends and to locate similar data.

In operation, the data mining engine component 504 is capable of extracting specific data and/or identifying patterns and trends associated with data maintained within a health-related data network. It is to be understood that the health-related data network can be a distributed network of sources (as shown in 104 of FIG. 1) such as disparate health-care providers or entities within a single provider facility (e.g., Radiology, Pharmacy, Records). Alternatively, the health-related data network can be a local store that maintains data of varying types and formats, as well as a combination of local and distributed sources.

More particularly, the data mining engine component 504 provides a mechanism that can identify implicit, previously unknown, and potentially useful information from the data housed in the communicatively coupled data repository(s) within the health-related data network. For example, the data mining engine component 504 can discern or recognize patterns and/or correlations amongst the available health-related data. The data mining engine component 504 can employ a single or combination of analysis techniques including, without limitation, statistics, regression, neural networks, decision trees, Bayesian classifiers, Support Vector Machines (SVMs), clusters, rule induction, nearest neighbor and the like to locate hidden knowledge within data. In one instance, a data-mining model is built and trained. Subsequently, the trained model can be employed to identify patterns and/or correlations.

The policy component 506 can be employed to define preferences, thresholds, regulations or the like with regard to functionality of the data collection component 106. For example, polling frequencies, similarity granularity, privacy issues, or the like can all be defined and effected by way of the collection policy component 506.

In one aspect, the data collection component 106 provides for mechanisms for applying a date-scope to select a cohort of records based on the existence of any attribute on any date within the date-scope. Thus, a record will be included in the cohort if the attribute was present for any amount of time, no matter how long or short, during the range of the currently-defined date-scope. It will be understood that a ‘cohort’ as used herein refers to a group of data elements sharing a common factor, for example, same patient, same context, same diagnosis, same demographics, etc. In a particular example, it can be possible to choose to see all the patients who were in an intensive care unit or other defined location for any amount of time during a defined range of dates or times. In this example, the collection policy component 506 can further be employed for defining which data elements from a set of databases are to be displayed, and for setting a display alias for each field name, along with other attributes for each column and for the entire cohort.

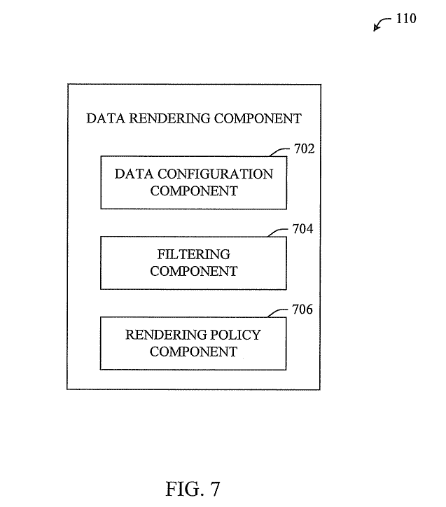

The collection component 106 can also be employed to cause any data elements for any cohort of records to be immediately exported, a) to a data file in any common standard format, or b) to any external program capable of receiving the data and processing or displaying it in any way, or c) to any other machine accessible by any communications method. These examples will be better understood upon a review of the data rendering component 110 illustrated in FIG. 7 that follows.

As described above, the data collection component 104 provides mechanisms for receiving data from most any source. The analysis component 106 that follows provides for processing the data in such a way as to create single data atoms, removing any (received or implied) associated structure and converting the information previously encoded in the data structure into the same information encoded as a series of attributes associated with the unitary data atom. Data atoms and their attributes can be stored together in a database (local, remote, distributed or combinations thereof) in such a way that every type of data element can be stored in exactly the same way, facilitating the task of receiving and managing disparate data types, and permitting the database (or sources) to be optimized without regard for specific data structures. At the time of retrieving the data for viewing (e.g., rendering) or for any other purpose, attributes associated with the data are also retrieved in such a way that the original structure or any other arbitrary structure may be transparently applied or reapplied to the data. In this way, the data may be received in most any format and later presented in other structured formats without a need to modify any underlying data structures.

Moreover, the collection component 106 (and subcomponents thereof 502, 504, 506) facilitates selection of items from nested groups of groups of items, where groupings can be nested arbitrarily deeply, in order to facilitate choosing items for some subsequent processing. A dictionary of items can define each item along with a series of attributes (e.g., tags) that describe the item and may define actions to be taken with the item. Items can be non-uniquely tagged as belonging to groups, such that any item can belong to any number of groups, and any group can likewise belong to any number of groups at the next higher level in the nesting.

Additionally, any group may contain disparate items of many types and may be treated as a single composite item simply by being included in another group at the lowest level, automatically permitting all the items in the included group to be selected with a single click. The source interface component 502 can effect a chooser-navigator that may be entered at the top level and browsed downward to the lowest level of groups, containing items to be chosen. Alternatively, the navigator may be entered at any intervening level, including entry at the level of a single leaf group which contains a single grouping of items. When an individual item or a composite item is selected, the item's attributes are evaluated and processed as needed. If an attribute indicates that more information is required from the user, a prompt can be triggered that instructs the user to enter the additional data, which may be selected from a predefined list or may be entered de novo as appropriate.

It is to be understood that the collection policy component 506 can be used to enable specific groups to be identified as belonging to a specific user or group of users. By way of example, private groups of items can made visible only to their owners and to members of their owner groups. Essentially, the policy component 506 can be employed to apply most any rule, preference or inference to the data, for example with regard to collecting, parsing, storing, etc. as deemed appropriate.

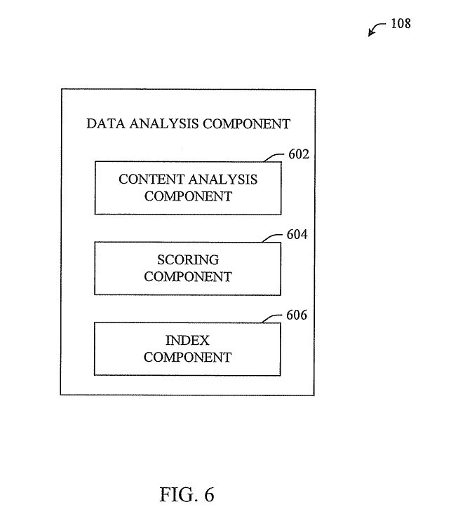

When collecting data, arbitrary data structures can be received and automatically deconstructed into core data elements and attributes without any foreknowledge of the meaning of the data. In this manner, unexpected data may be received without warning and may still be processed, stored, retrieved, and displayed to the user as needed. This functionality can be effected by way of the analysis component 108 illustrated in FIG. 6. As shown in FIG. 6, generally, the analysis component 108 can include a content analysis component 602, a scoring component 604 and an index component 606.

The content analysis component 602 can employ most any analysis techniques known in the art to extract data from health-related data elements. For example, pattern recognition mechanisms can be employed to determine descriptive criteria associated to an image data element. More specifically, pattern recognition can be employed to determine if an image is an X-ray, CT scan, MRI, etc. Additionally, textual information and other identifying indicia included within the image can be recognized and interpreted. These interpreted criterion can be associated with the data element and thereafter used to effect search and/or intelligent rendering of data.

A scoring component 604 can be employed to determine a relevance score with reference to a particular activity or as compared to other data elements. Accordingly, the index component 606 can be employed to establish and maintain an index that interrelates data elements based upon determined criterion/attributes and/or score relevance. Essentially, this index can be viewed as a mapping between the data elements such that data elements from a variety of sources and of different types can be rendered (or made available) via a unified UI thereby enhancing usability of patient-related data. Rather than having to access a variety of sources for data related to a patient or a patient context (current office visit for a specific issue), the index enables an intelligent and sophisticated mechanism whereby data can be selected and subsequently rendered based upon relevance to the patient (or current context of the patient).

Referring again to the content analysis component 602, the innovation can recognize identifiers placed upon scanned images. For example, mechanisms that facilitate the scanning of documents and the assignment of correct identifiers to associate each document with the correct person or place, or thing, or process are provided. One useful feature of the content analysis component 602 is that it permits document scanning and input by persons untrained in the process, without the likelihood of human error in the assignment of scanned documents to their correct place or relevance (e.g., score) assignment. ‘Scanning’ includes most any method for creating an image of the document.

In operation, identifiers (e.g., bar-codes) can be added to the document prior to scanning. These identifiers can be of a sort that can be automatically detected and decoded by the content analysis component 602 as part of the scanning process. Identifiers may be, but need not be, visible to the human eye. Identifiers may be placed on the document at the time of original document creation, as part of the primary printing process, and at any time thereafter prior to scanning. Examples of identifiers would include, but are not limited to, magnetic marks, optical marks, or other detectable physical or chemical markings. Identifiers may be printed on or otherwise applied directly to the page or may be present on labels that are affixed to the page, as in bar-code labels.

In an aspect, each document can receive several classes of identifiers, including, but not limited to such identifiers as a document type identifier (form ID), a person identifier (case ID), and a page identifier (page ID). These identifiers can be detected at the time of scanning, and used to assign the document to a correct category (or set of categories), including the correct form type, and to the correct person. The unique page ID is also used to detect whether a particular scanned document image is an additional example of the same form type or whether it is in fact a re-scan of a previously scanned page. As described with reference to the methodology of FIG. 3, if the document is a duplicate, it can be discarded so as to not consume storage space.

In operation, the data analysis component 108 can be employed to detect when duplicate images are received either alone or as embedded portions of a larger data structure that may differ in the non-image portions of the data, for example, as when two copies of an identical x-ray are transmitted with different descriptive headers. Recognition of duplicates is particularly important for many reasons. One obvious reason that this is important is that, if the same x-ray is transmitted twice with two different headers associating the image with two different patients, one of the two must be incorrect. An algorithm can be used to compare successive portions of multiple images until differences are found or until the likelihood that the two images are the same exceeds a user-defined confidence threshold (e.g., collection policy component 506 of FIG. 5).

This situation resolves a common problem in that two files may differ in their text portions but not in their image portions, where recognizing the two images as the same may reduce the space needed for storage and may facilitate user interaction with a simplified list of images. The selection of algorithms may be based upon calculated hashes, checksums, Eigen-images, or other calculated abstractions, or upon direct bitwise comparison.

Because of the nature of health-related data, it will be appreciated that access tracking mechanisms can be employed to log activity. In other words, the innovation can log each episode of data retrieval and display with all identifiable attributes of the episode, including the date and time, the IP and MAC address of the request, the network traversal route between requester (e.g., client) and server, the client machine name, the logged-in user, the token used to authenticate, the data requested, etc. Moreover, it is to be understood that the logging mechanisms and displays facilitate meeting regulatory requirements for tracking and auditing access to data, as in HIPAA (Health Insurance Portability and Accountability Act) requirements.

The analysis component 108 can further provide mechanisms for auditing utilization of specific resources related to the collection and rendering of health-related data. Data elements received by the system can be tagged with a number of different identifiers indicating such attributes as the entity being described by the data element, the entity responsible for the creation of the data element, the location and time of creation, and an unlimited number of other such attributes. This tagging structure is as illustrated in FIG. 2 described supra. The system can then calculate a number of events of each type associated with each entity, permitting automatic comparison across entities with respect to activity or utilization of any resource. Views can then display relative utilization information, and automatic reporting mechanisms can generate reports and alerts based on the fulfillment of arbitrary conditions. Example applications of this calculation can include profiling users on the basis of test utilization, medication utilization, length of stay, productivity, etc.

Referring again to a discussion of the collection component 104, as described above, in addition to initial data element intake, this component can facilitate abstracting one or more elements from a list of elements, where the abstracted elements are of particular interest for display or processing in some other context. Accordingly, the component can employ (or include) an accumulator object which may or may not be visible, and a selector object that is capable of displaying all data elements meeting any arbitrary criteria and can allow the user to indicate or select individual elements by some means (e.g., unified UI), where selected elements are copied from the selector object into the accumulator object. Thereafter, the elements can be rendered, displayed or used in any way by subsequent objects or processes. The data rendering component 110 enables this functionality conveying the elements as desired.

FIG. 7 illustrates an example data rendering component 110 having a data configuration component 702, a filtering component 704 and a rendering policy component 706. Overall, the rendering component 110 facilitates providing a cohort of health-related data to a display device or other application as an input for processing. Each of the sub-components will be described below in greater detail.

The data configuration component 702 facilitates normalizing and/or standardizing data into a common format which enables unified display of information of varying formats and/or from varying locations. The filtering component 704 can be employed to effect standard searching/querying as well as context filtering of data elements to render a comprehensive set of documents for display. As well, the filtering component 704 can be used to filter privacy information thereby reducing exposure to confidential and/or sensitive data. The filtering functionality as well as configuration functionality can be managed by a rendering policy component 706. For example, the data rendering component 702 can automatically configure and filter data based upon a user context (e.g., location, time of day, device used, activity engaged, etc.). These automatic actions can be effected by way of the rendering policy component 706 or alternatively, by machine learning and/or reasoning (MLR) mechanisms.

With regard to MLR mechanisms, the innovation can employ these mechanisms to automate one or more features descried herein. The subject innovation (e.g., in connection with filtering) can employ various MLR-based schemes for carrying out various aspects thereof. For example, a process for determining how to code, establishment of relationships between data elements, how to filter, how to render, etc. can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

An SVM is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions associated with the functionality described herein.

One example of a use for such functionality is to allow medical personnel to abstract information of immediate interest from the large amount of information generated for each patient each day, in order to produce an ‘executive summary’ report or abstract showing only results of interest. Another example use is to allow periodic validation of data elements entered or created at a prior time, by displaying all the prior elements in the selector and requiring that each element be selected in order to be brought forward to the current record—as when demographic information must be validated at the time of registration, or when nutrition orders must be reviewed and renewed on a daily basis.

The data rendering component 702 enables displaying (or otherwise rendering) selected fields from all records belonging to a cohort of records within a series of databases, where a series of filters are used to define the cohort, and the filters are created and modified as needed by the user or by an administrator using a policy, and are created through most any Boolean combination of requirements placed on any data elements within the databases. Further, the data rendering component can enable making the most-used filters more readily available for defining the most common types of cohorts, by creating a series of predefined selectors for choosing from predefined filters such as a date-scope, location, group membership, etc.—all of which can be included within the policy 706.

With regard to tables, the data rendering component 110 is able to create a display cohort from data derived from a multitude of tables, where to the user it appears that the data comes from a single table. The policy 706 enables definition of the data fields that are made available to be displayed based upon one table or view, while using different tables or views to define the data fields that are used to define the cohort of records for display. The technique can include mechanisms for automatically switching to a different cohort-defining table or view as needed when the user wishes to select or define a different cohort, and for doing so in such a way that the data fields displayed remain the same and the user is unaware of any change in the underlying context.

In operation, the rendering component 110 enables definition of which data elements from a set of databases are to be displayed based upon defined or inferred factors, and for setting a display alias for each field name, along with other attributes for each column and for the entire cohort. Still further, in one aspect a screen view can be converted into a printed report by assigning the space available on the printed page pro-rata based upon the fraction of screen space assigned to each data element. This assignment criterion can be predefined (e.g., based upon a policy 706) or inferred using MLR-based mechanisms.

It can also be possible to mark selected data records or elements as ‘hidden’ such that their existence is not visible to the user, or so that their existence is visible but the data contained in the records is not accessible. It will be appreciated that this functionality addresses privacy concerns and regulations, for example, those imposed by HIPAA, while still retaining the data as may be required by other policies and/or regulatory agencies.

As described above, the innovation enables embedding within one primary object or form or process a secondary object or component having the ability to display specific data elements drawn from one or more databases. As well, the innovation enables the ability to invoke one or more separate tertiary objects or components or programs that can perform editing functions, including creation and deletion, on the specified data elements and other related data elements. Further, it is possible to effectuate an ability to automatically detect completion of an editing function performed by the tertiary object and subsequently to refresh the display in order that the results of any editing will immediately become available and/or visible within the secondary object. Thus, these edited objects will be available and/or visible within the primary object or form or process, without any need for the primary object to have any knowledge of or direct interaction with any of the data elements being displayed or with any of the objects used to edit those data elements.

As described supra, the innovation can provide for maintaining lists of attributes of different types for any entity, including a component capable of a) switching from one type of attribute to another through the use of tabs or some other user-activated selector, b) displaying the list of attributes of the selected type, c) creating a new attribute of that type or editing any part of an existing attribute, d) setting a start date for that attribute, e) creating identifiers indicating the person or process responsible for creating or editing the attribute, f) creating or editing additional information that may be associated with that attribute, g) indicating that an attribute is no longer active or no longer applicable, h) setting a stop date for that attribute, i) indicating the person or process responsible for the termination of the attribute, j) applying security rules to determine whether a given user is permitted to perform any of these actions, k) storing and maintaining the lists within a database or other data store, from which location the data may be available for use by other processes and systems, l) retrieving and displaying the lists in such a way as to indicate which attributes of each type are currently active and which have been terminated or marked inactive, and m) carrying out such other actions as may be desirable in the context of the management of such attribute lists.

As stated above, the innovation is applicable to health-related or patient-related data of any type and in any area of endeavor. As well, the innovation is applicable to data outside the health-related scenarios. An example of financial management data lists would be a list of stop orders for stock disposition, with associated information indicating under what conditions the stock should be sold, where stop orders that had been cancelled or superseded were displayed with attributes indicating the same—for example, with a strikeout attribute and a cancellation date. An example from the medical field would be a list manager for allergies, current problems, current medications, intravenous lines, where the user can elect to see the current problem list and can then add and terminate problems as the patient's condition changes, while all prior (inactive) problems are displayed with attributes indicating their inactive status—for example with a different color and a cancellation date.

The innovation is able to automatically populate a list or view (e.g., via rendering component 11) that associates patients and physicians, by reading information from a variety of other sources such as lab orders, radiology orders, dietary orders, registration information, logs showing who has looked at each patient's data, and so forth. Most any interaction that can connect a clinician with a patient, directly or indirectly, can be used to help infer (e.g., via MLR) the clinician's role with respect to the patient. A variety of rules, algorithms, and methods may be applied to the relationship mesh, including such methods as neural networks, fuzzy-logic, regression, Bayesian analysis, and most any other analytic method.

Whenever a clinical user views patient data, a presumption is usually made that the user has a valid clinical relationship with the patient, thus the user name can be automatically added to a list of that patient's clinicians. The list of a patient's clinicians can be published as part of a clinical summary, together with an indication of what types of actions have been taken by each clinician (e.g., viewed data, placed orders, wrote notes, etc.) Persons tempted to view clinical data when that is not appropriate will be deterred by the knowledge that their having done so will automatically be known to all the patient's other clinicians. It will be appreciated that, if looking at a patient's data automatically adds a person to a publicly-viewable list of that patient's clinicians, the risk of inappropriate data viewing will be reduced.

As mentioned above, filtering mechanisms can be employed to reduce risk of inappropriate access to patient data. The innovation described herein enables mechanisms for allowing patients to have access to a personal health record with reduced risk of loss of privacy. Screens may contain patient-specific data, but the identification of the patient can be masked such that it does not appear anywhere on the display. Accordingly, the person viewing the screen must have some other way of knowing to which patient the information applies or sufficient credentials to enable display of the patient information. The screen may contain a one-time PIN (personal identification number), along with information about the date and time of the visit, the name of the doctor and nurse and other staff, the problem for which the visit was made, the medications prescribed, the follow-up recommended, and other information sufficient to uniquely identify the visit. At discharge, the patient receives a card or other document containing a PIN and a location (e.g., a web URL (uniform resource locator) or a socket or a phone number) from which the clinical data may be retrieved, together with other printed information that must match the information on the screen.

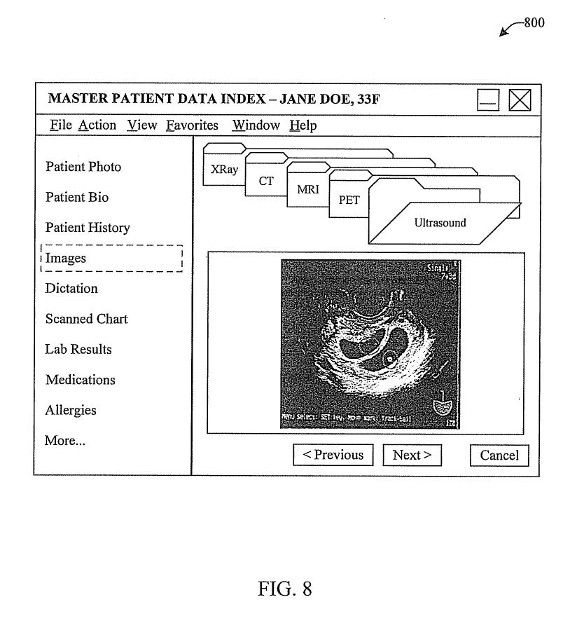

Turning now To FIG. 8, an example screen print 800 of a system that facilitates the aforementioned functionality is shown. It is to be understood and appreciated that this screen print is provided to add perspective to the innovation and is not intended to limit the innovation in any way. Accordingly, other configurations and ways of rendering data in accordance with the aforementioned functionality are to be included within the scope of this disclosure and claims appended hereto.

As shown in the master patient index view 800 of FIG. 8, the header can include the patient name (e.g., Jane Doe), age (e.g., 33) and sex (e.g., F). In alternative aspects, this information can be masked for privacy or only attainable upon authentication/authorization mechanisms with respect to the health care professional that desires to view the information. Similarly, additional or less information can be provided as desired.

Essentially, the screen print 800 enables a unified view of a variety of patient-related information. As shown, on the left side of the screen is an example list of information available via UI 800. Here, as denoted by the dashed box, ‘Images’ has been selected as the category for display.

Accordingly, as shown, multiple folders can be displayed that related to sub-categories under the selected category. Continuing with the ‘Images’ category, as shown, ‘X-ray’, ‘CAT’, ‘MRI’, ‘PET’, and ‘Ultrasound’ are displayed in accordance with this example. To select a category, a user can employ a navigational device (e.g., mouse, trackball) or keys (e.g., arrows on a keyboard) to select the desired category. In other examples, gesture commands, voice commands or the like can also be employed to select a desired category.

As illustrated, ‘Ultrasound’ has been selected and is confirmed by the open folder shown in the screen print 800. Thus, the first image is displayed whereas ‘Previous’ and ‘Next’ navigational buttons can be used to scroll through the images. In other aspects multiple images can be displayed simultaneously. As well, images can be resized as desired by the user, for example, by hovering and clicking on the image, etc.

Although the example illustrated in FIG. 8 is directed to rendering an ‘Ultrasound’ image, it will be understood that the UI can also display alphanumeric reports, video, audio or the like. These alternative examples are to be included within the scope of the disclosure and claims appended hereto.

Following is a list of other methods that can be performed in accordance with the functionality described herein. As such, these additional methods are to be included within the scope of this disclosure and claims appended hereto. Moreover, it is to be understood that the aforementioned systems described herein are capable of practicing the following methods.

A method for selecting an optimal combination of appropriate diagnostic and procedure codes in order to maximize the level of reimbursement from third-party payers. All data entered by physicians, nurses, and coding staff are merged with data from any number of arbitrary data sources, including equipment dispensing systems, OR (operating room) systems, pharmacy systems, etc. The data reflecting all available diagnoses and procedures for an individual patient is compared with historical payment data for all prior patients, sorted by payer, and alternative presentations of the data are ranked by likelihood of maximal reimbursement. Inconsistencies in diagnostic and procedure coding are identified, and patients whose resource utilization is higher than the likely reimbursement are flagged for review and for a variety of potential interventions.

A method for creating disparate applications by choosing a global container from a library of existing containers, choosing components from a library of existing components, and choosing data sources from a library of existing data sources. An application so designated thus includes data sources and component objects and global methods and attributes, including those defining the look and feel of the application and the user interface. An application thus defined can provide a plurality of potential functions and data displays whose visibility or expression may be limited based upon the identity of the user, the location of use, the time of day, the number and identity of other users, the method of authentication of the user, and other attributes of a use session. A large variety of different applications can thus be assembled very quickly from the same library of components.

Method for embedding a component that shows database data and calls another component to modify it. Method for handling rules at the time of choosing an item, before adding the item to an accumulator. Method for creating an application by choosing from a library of components and data sources. Method for wrapping a data-capture operation that creates one or more copies of a series of data elements (ordinarily one blob per row) within a managing layer so that each blob receives a date-time stamp, an owner, a title, and other arbitrary attributes, thus permitting a component that creates a single copy of a dataset to instead create multiple copies that are distinguished on the basis of one or more attributes.

Method for passing data along a chain of processing by means of registration within queues to which another process is subscribed. Method for improving database maintainability by restricting each parsing script so that it can only write to a single table, and so that each field is written to by exactly one script. Method whereby an application can adjust its behavior in response to knowledge about the speed of the connection, the conditions on the network, latency or packet loss or other degradation or enhancement of end-to-end connectivity.

Method whereby data that normally is not represented graphically can be displayed through a variety of mappings into graphical spaces that have no ‘realistic’ connection to the data being displayed, in order to afford a human operator the opportunity to recognize patterns that may otherwise not be recognized.

Method for assuring rapid recovery in the event of data loss or corruption that has propagated across live replication copies of the data. Each day an out-of-date replication copy of the database can be brought live and replication is re-enabled, allowing the copy to be brought up-to-date. The copy is then taken off-line, and may be powered down and disconnected, with such other actions as may be useful to protect the copy against threats. This process can be repeated each day, with as many distinct historical replications as may be desired. Historical copies can be brought live in rotation; for example, if one copy is kept for each day of the past week, then the copy that is one week old is brought current each day. This method can allow for the most rapid possible recovery when data errors affect all live replicated copies of the data and are not detected for one or more days, up to the number of days age of the oldest offline replication.

A method for obtaining a list of data elements and a count of the number of members in that list through concurrent processes. It is common that a database query using any language (e.g., SQL) may return a number of rows of data without being able to simultaneously return the count of the total number of matching rows that exist within the database, or that the count is returned but at the expense of longer delays. This method creates two copies of the query, one to retrieve rows and one to retrieve just the count, and submits the two queries to two different replicated copies of the same database. The two processes thus occur in parallel, and the final result is displayed more quickly. This method can be applied to most any data storage and retrieval system running on most any processor using most any operating system and most any retrieval language, and may be integrated into applications of most any type.

A method whereby each client maintains a list of potential primary servers to which it may connect, and attempts to connect to each one in some order. The order may be randomized, or it may follow a pattern or may be predetermined by another method. Upon connection to a primary server, the client then may receive one or more lists of servers that can provide additional types of data, including an updated list of primary servers that may replace the original list of primary servers. Whenever a particular type of data is being retrieved from a particular server, if that connection fails to meet arbitrarily defined criteria for acceptability, the client can automatically try to retrieve the data from another server on that particular list. This switch to an alternate server may be triggered by inability to find a server, loss of connection to a server, accumulation of data transfer errors exceeding some threshold, speed of data transfer, a signal passed from the server indicating some information about conditions of that server, or any other combination of conditions, facts or circumstances. Each server in a list may have a different associated connection method.

Method to integrate non-medical data with medical data (e.g., weather, climate, location, context). A method for detecting cases of a particular problem that is clinically unrecognized, such as thrombocytopenia or diabetes and for notifying appropriate clinicians and ensuring that appropriate charge coding is performed and appropriate consultation and follow-up is obtained.

Method for displaying a patient photograph on data screens, to reduce the risk of errors related to confusing one patient with another patient. A method for tagging patients with arbitrary keywords at the moment of arrival, in order that cohorts can be created on-the-fly.

Methods for analyzing hospital efficiency through aggregation of data and creation of graphs and analytical, statistical and historical models. Graphing measures of movement between different locations, e.g., the number of patients who moved from one room to another. A method for placing most any function into a clinical document, because the document consists of an arbitrary number of objects, each one of which is a computer program in and of itself, capable of performing functions.

Method for printing prescriptions and automatically adjusting the size and shape to match the paper that is loaded. Method for automatically suppressing the DEA (Drug Enforcement Agency) number and other information when the drug does not require it. Method for automatically detecting for patterns of abuse. Method for receiving information about a patient who is being referred, and for marrying that information to the principal repository of information about the patient. Method whereby a referring physician can automatically generate a referral using a web interface.

Method whereby geocoding data is used to identify the fact that addresses are not valid. Method to effect an ability to view data either in the grid rows, or in a pop-up using info-viewers for multi-value data types, or as columnarized data elements. Method to effect an ability to choose data fields of any type, from any source, to be displayed with arbitrary formatting rules and in any order, using arbitrary column headings for display on the grid.

A method for providing pseudo-de-identified data that appears to have patient identification, using randomly-assigned identifiers. A method for instantly re-identifying the data at times of need, for example, when a public health disaster forces contact tracing.

Methods to track old or ‘out dated’ versions of scanned documents and to distinguish different pages from different copies of the same page scanned twice. Methods to extract headers from dictations and chunk the material into data atoms. Methods to integrate primary fields with user-defined fields or fields that are derivative of primary data source fields.

Method for rapidly creating workflow lists using filters and views. A method for causing an arbitrary secondary event to be triggered based on the occurrence of any arbitrary combination of conditions applied to any combination of data elements, time events, or physical events that are detected by any method. The secondary event can further trigger additional events, so that any combination of alarms and alerts may be triggered, including but not limited to emails, pager alerts, screen messages, modifications of user privileges, file transfers, sounds, lights, door locks, or any other physical or virtual action. Accordingly, a method whereby such rules can be created by an end-user. For example, a rule might notify a doctor when a patient begins to develop renal failure, if that patient is on a drug known to contribute to renal failure. Another rule might notify an administrator when the waiting time in some hospital department exceeds a predefined threshold.

A method for predicting admission based on information known early in the patient's course. A method for predicting the volume of admissions that will occur on a given day. A method for predicting when patient volumes will exceed capacity. A method for predicting which patients will overstay their expected time-in hospital.

Methods to join an external file (e.g., spreadsheets) and treat it as though it were internal data. This join can be accomplished without a need for a systems administrator to assist. Method of applying a filter based on most any Boolean combination of any data elements. Method for showing the root-source data rapidly when final data is being seen in some context. Methods for automatically mapping data elements to a desired or appropriate form, for example, un-valued fields simply do not appear.

Methods for juxtaposition of any data items, without regard of the origin. Method to manipulate different data types using all the same tools merge data types in a uniform environment. Since the same tools are used for all data types, and since data of different types are seamlessly managed, people in different departments who have different needs can nonetheless use the same system which leads to improved organizational integration.

Method to permit transparent use of financial, clinical, image, etc. all in one unified system. Methods to juxtapose date of different logical types in the same display, e.g., date-time data, counts of events, clinical details, etc. all in one place. New data fields can be made of derivative data types—from a single type, from multiple fields, or meta-data conveying information about the entire process or about the existence or distribution of other data. Data fields can be defined by scripts that can perform arbitrary actions in deriving the contents of the field.

Methods that enable an ability to have user-defined data entry screens produce data. For example, when zooming is desired in on a nuclear medicine image, it is not always helpful to just magnify the pixels up into big blocks. Rather, it is sometimes helpful to produce an interpolated magnification. For all images a method can be applied to set some maximum block size for representing each pixel when zooming in, and then zoom in normally as long as there are enough pixels available. Subsequently, interpolation can begin, rather than to display ever-larger blocks of pixels, which makes the image unreadable, when zooming beyond the limit of the data.

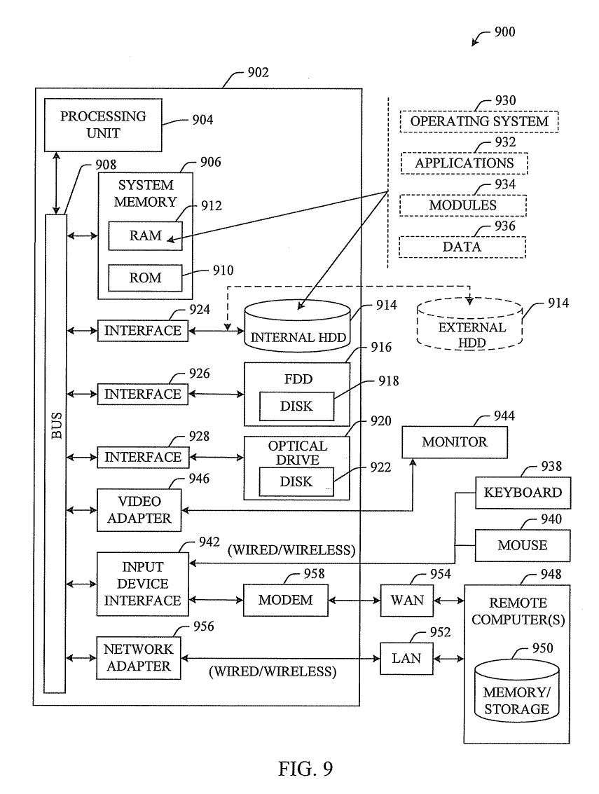

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

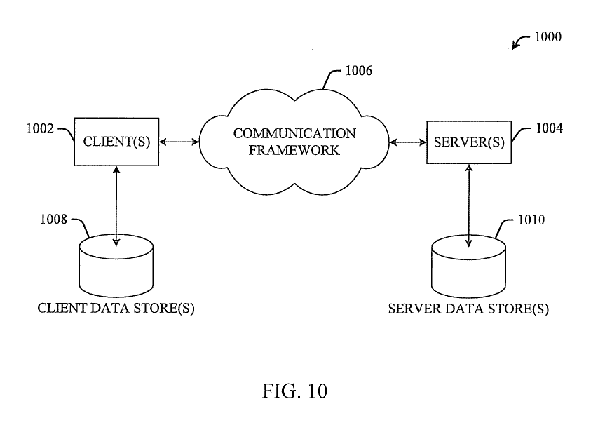

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates cross-relating health-related data, comprising:
an interface that establishes a gateway to a health-related data network that includes a plurality of health-related data elements of disparate formats; and
a data management component that employs the interface to collect or access a cohort of the plurality of data elements maintained within the health-related data network.

2. The system of claim 1, the disparate formats are at least two of text documents, medical imaging documents, electrocardiograms, lab result documents, patient photographs, patient biographical information, audio files, dictation files or scanned images of patient charts.

3. The system of claim 1, further comprising a data collection component that facilitates identification of the cohort of the plurality of data elements as a function of a similarity score applied to each of the plurality of data elements.

4. The system of claim 3, further comprising a data mining engine component that identifies relationships between the plurality of data elements and establishes the cohort of the plurality of data elements as a function of the relationships.

5. The system of claim 3, further comprising a collection policy component that includes a rule based upon a user preference, wherein the data collection component employs the rule to identify the cohort of the plurality of data elements.

6. The system of claim 1, further comprising an analysis component that establishes an index which interrelates the cohort of the plurality of data elements, wherein the data management component employs the index to collect or access the cohort of the plurality of data elements.

7. The system of claim 6, further comprising a scoring component that establishes a similarity score associated with each of the plurality of data elements as a function of other of the plurality of data elements, the index component employs the similarity score to establish the index.

8. The system of claim 7, further comprising a content analysis component that establishes criteria based upon content of each of the plurality of data elements, wherein the scoring component employs the criteria to establish the similarity score.

9. The system of claim 8, wherein the content analysis component employs at least one of keyword recognition, pattern recognition, speech recognition or optical character recognition to establish the criteria.

10. The system of claim 1, further comprising a data rendering component that facilitates rendering the cohort of the plurality of data elements to at least one of a display and an application.

11. The system of claim 10, further comprising a data configuration component that automatically configures each of the cohort of the plurality of data elements based upon the at least one of the display or the application.

12. The system of claim 10, further comprising a filtering component that filters the cohort of the plurality of data elements prior to rendering.

13. The system of claim 10, further comprising a rendering policy component that includes a rule that regulates the rendering of the cohort of the plurality of data elements.

14. The system of claim 1, further comprising a machine learning and reasoning component that employs at least one of a probabilistic and a statistical-based analysis that infers an action that a user desires to be automatically performed.

15. A computer-implemented method of rendering a cohort of health-related data elements having differing formats, comprising:
accessing a plurality of health-related data elements;
applying a similarity score to each of the plurality of data elements;
identifying the cohort of health-related data elements from the plurality of data elements as a function of the similarity score; and
rendering the cohort of health-related data elements to at least one of a display or an application.

16. The computer-implemented method of claim 15, further comprising establishing an index as a function of the similarity score, wherein the index is employed in the act of identifying the cohort.

17. The computer-implemented method of claim 15, further comprising:
establishing search criteria, wherein the search criteria is employed in the act of identifying the cohort of health-related data elements.

18. A computer-implemented system that facilitates identifying a cohort of medical data elements, comprising:
means for accessing a plurality of medical data elements of different formats;
means for analyzing each of the plurality of medical data elements;
means for interrelating the plurality of medical data elements as a function of the analysis;
means for establishing the cohort of medical data elements as a function of the interrelation.

19. The computer-implemented system of claim 18, further comprising means for rendering the cohort of medical data elements.

20. The computer-implemented system of claim 18, further comprising:
means for displaying the cohort of medical data elements; and
means for navigating to each of the cohort of medical data elements via a unified user interface.
